(19) United States
(12) Patent Application Publication
(10) Pub. No.: US 2011/0057508 A1
(43) Pub. Date: Mar. 10, 2011

(54) ENDLESS TRACK FOR AN OFF-ROAD WORK VEHICLE TO PRODUCE A NET NON-NULL LATERAL FORCE

(76) Inventor: Marc Delisle, Magog (CA)

(21) Appl. No.: 12/920,054

(22) PCT Filed: Feb. 27, 2009
(86) PCT No.: PCT/CA09/00246

§ 371 Date: Nov. 24, 2010

Related U.S. Application Data
(60) Provisional application No. 61/032,247, filed on Feb. 28, 2008.

(51) Int. Cl. B62D 55/24

(52) U.S. Cl. 305/165

(57) ABSTRACT

An endless track for providing traction to an off-road work vehicle (e.g., a construction vehicle, agricultural vehicle, or forestry vehicle). The endless track has a longitudinal axis and comprises an inner side for engaging a drive wheel of the off-road work vehicle to move the endless track and a ground-engaging outer side for engaging the ground. The ground-engaging outer side comprises a tread pattern characterized in that, when the off-road work vehicle moves on the ground, the tread pattern produces lateral traction force components acting laterally on the endless track such that a resultant of the lateral traction force components is a net non-null lateral force acting on the endless track in a lateral direction generally perpendicular to the longitudinal axis. For example, the net non-null lateral force can be used to oppose undesirable side loads and/or tendencies for lateral movements that may be experienced by the endless track due to intrinsic mechanical imbalances which may arise in the vehicle (e.g., “toe-in”, negative camber, etc.), motion of the vehicle on the ground (e.g., if the vehicle turns almost exclusively or significantly more often on one side), and/or use of a working implement with which the vehicle may be equipped.

### CROSS-REFERENCE TO RELATED APPLICATION

This application claims priority from U.S. Provisional Patent Application No. 61/032,247 filed on Feb. 28, 2008 and hereby incorporated by reference herein.

### FIELD OF THE INVENTION

The invention relates to endless tracks for off-road work vehicles, such as construction vehicles, agricultural vehicles, forestry vehicles, and other vehicles designed for other types of industrial work in off-road conditions.

### BACKGROUND

Off-road work vehicles, such as construction vehicles (e.g., bulldozers, loaders, backhoe loaders, excavators, etc.), agricultural vehicles (e.g., harvesters, combines, tractors, etc.) and forestry vehicles (e.g., feller-bunchers, tree chippers, knuckleboom loaders, etc.), are often equipped with endless tracks which enhance their traction and reduce pressure they apply on soft, low friction and/or uneven grounds (e.g., soil, mud, sand, ice, snow, etc.) on which they operate.

In some situations, an endless track of an off-road work vehicle may experience undesirable side loads and/or lateral movements that can have adverse effects on the endless track, such as accelerate its wear (e.g., accelerate wear of inner drive/guide lugs of the endless track) or promote its detracking. For example, in some cases, such undesirable side loads and/or lateral movements may be due to intrinsic mechanical imbalances which may arise in the vehicle (e.g., “toe-in”, negative camber, etc.), motion of the vehicle on the ground (e.g., if the vehicle moves on an inclined ground area, or turns almost exclusively or significantly more often on one side), and/or use of a working implement (e.g., a dozer blade, a bucket, a grapple, a combine head, etc.) with which the vehicle may be equipped (e.g., if the working implement causes the vehicle to be subjected to a higher loading on one of its sides).

For these and other reasons, there is a need for solutions directed to opposing undesirable side loads and/or tendencies for lateral movements that may be experienced by endless tracks of off-road work vehicles.

### SUMMARY OF THE INVENTION

According to a first broad aspect, the invention provides an endless track for providing traction to an off-road work vehicle. The endless track has a longitudinal axis and comprises an inner side for engaging a drive wheel of the off-road work vehicle to move the endless track and a ground-engaging outer side for engaging the ground. The ground-engaging outer side comprises a tread pattern characterized in that, when the off-road work vehicle moves on the ground, the tread pattern produces lateral traction force components acting laterally on the endless track such that a resultant of the lateral traction force components is a net non-null lateral force acting on the endless track in a lateral direction generally perpendicular to the longitudinal axis.

According to a second broad aspect, the invention provides a method for opposing a tendency for an endless track of an off-road work vehicle to move in a first lateral direction as the off-road work vehicle moves on the ground. The method comprises: providing the endless track with a tread pattern that generates, as the off-road work vehicle moves on the ground, a net non-null lateral force acting on the endless track in a second lateral direction generally opposite the first lateral direction; and driving the off-road work vehicle to give rise to the net non-null lateral force.

According to a third broad aspect, the invention provides a method for reducing wear in an endless track of an off-road work vehicle carrying a working implement that creates a non-uniform lateral load distribution whereby the vehicle is subjected to a higher loading on one of its sides which tends to steer the vehicle in a first direction. The method comprises: providing the endless track with a tread pattern that generates, as the vehicle moves on the ground, a net force acting laterally on the endless track and tending to steer the vehicle in a second direction that is generally opposite the first direction; and driving the vehicle on the ground to give rise to the net force.

### BRIEF DESCRIPTION OF THE DRAWINGS

A detailed description of embodiments of the invention is provided below, by way of example only, with reference to the accompanying drawings, in which:

FIG. 1 shows an off-road work vehicle in accordance with an embodiment of the invention;

FIG. 2 shows a top view of a portion of an endless track of the off-road work vehicle shown in FIG. 1 in accordance with an embodiment of the invention;

FIG. 3 shows a side view of the portion of the endless track shown in FIG. 2;

FIG. 4 shows a cross-sectional view of the portion of the endless track shown in FIG. 2;

FIG. 5 shows an example of traction force components produced by a tread pattern of the endless track when the off-road work vehicle moves on the ground;

FIGS. 6 and 7 show top views of endless tracks having different tread patterns in accordance with other embodiments of the invention; and

FIGS. 8 to 12 illustrate examples of situations in which a net non-null lateral force produced by the tread pattern of the endless track can be useful.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

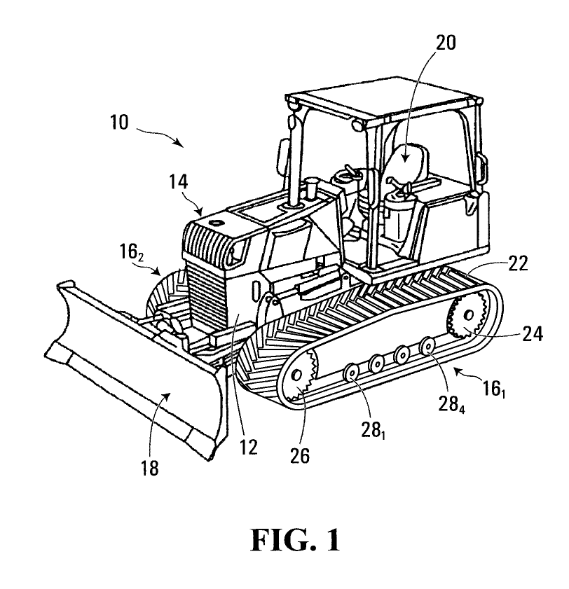

FIG. 1 shows an off-road work vehicle 10 in accordance with an embodiment of the invention. In this embodiment, the off-road work vehicle 10 is a construction vehicle designed to perform construction work. More specifically, in this example, the construction vehicle 10 is a bulldozer. In other examples, the construction vehicle 10 may be a loader, a backhoe loader, an excavator, or any other type of construction vehicle.

In this embodiment, the construction vehicle 10 comprises a frame 12 supporting a prime mover 14, a pair of track assemblies 16₁, 16₂, a working implement 18, and an operator cabin 20, which cooperate to enable an operator to move the construction vehicle 10 on the ground and perform construction work.

The prime mover 14 provides motive power to move the construction vehicle 10. For example, the prime mover 14 may comprise an internal combustion engine and/or one or more other types of motors (e.g., electric motors, etc.) for generating motive power to move the construction vehicle 10. The prime mover 14 is in a driving relationship with each of the track assemblies 16₁, 16₂ that is connected to the prime mover 14 via a power train or other power transmission mechanism of the construction vehicle 10.

The operator cabin 20 is where the operator sits and controls the construction vehicle 10. More particularly, the operator cabin 20 comprises a set of controls that allow the operator to steer the construction vehicle 10 on the ground and perform construction work using the working implement 18.

The working implement 18 is used to perform construction work. In this embodiment where the construction vehicle 10 is a bulldozer, the working implement 18 is a dozer blade that can be used to push objects and shove soil, debris or other material. In other embodiments, depending on the type of construction vehicle, the working implement 18 may take on various other forms, such as a backhoe, a bucket, a fork, a grapple, a scraper pan, an auger, a saw, a ripper, a material handling arm, or any other type of construction working implement.

The track assemblies 16₁, 16₂ are drivable by the prime mover 14 to propel the construction vehicle 10 on the ground. In this embodiment, each track assembly 16ᵢ (i=1 or 2) comprises an endless track 22 disposed around a drive wheel 24, an idler wheel 26, and a plurality of bogie wheels 28₁-28₄.

The drive wheel 24 is operative for driving the endless track 22 to propel the construction vehicle 10 on the ground. When driven by the drive wheel 24, the endless track 22 moves along an endless path around the wheels 24, 26, 28₁-28₄. The idler wheel 26 and the bogie wheels 28₁-28₄ do not convert power supplied by the prime mover 14 to motive force, but rather support and distribute part of the weight of the construction vehicle 10 on the ground as well as guide the endless track 22 and maintain it under tension as it is driven by the drive wheel 24.

The track assembly 16ᵢ may be configured in various other ways in other embodiments. For example, in some embodiments, the track assembly 16ᵢ may comprise an additional drive wheel (e.g., the idler wheel 26 may be replaced by a drive wheel) and/or may comprise more or less bogie wheels. Also, in some embodiments, the track assembly 16ᵢ may be provided on the construction vehicle 10 during manufacturing of the construction vehicle 10, while, in other embodiments, it may be installed at a later time (e.g., the construction vehicle 10 may initially be designed and manufactured to move on wheels and the track assembly 16ᵢ may be retrofitted to the construction vehicle 10 to replace one or more of its wheels).

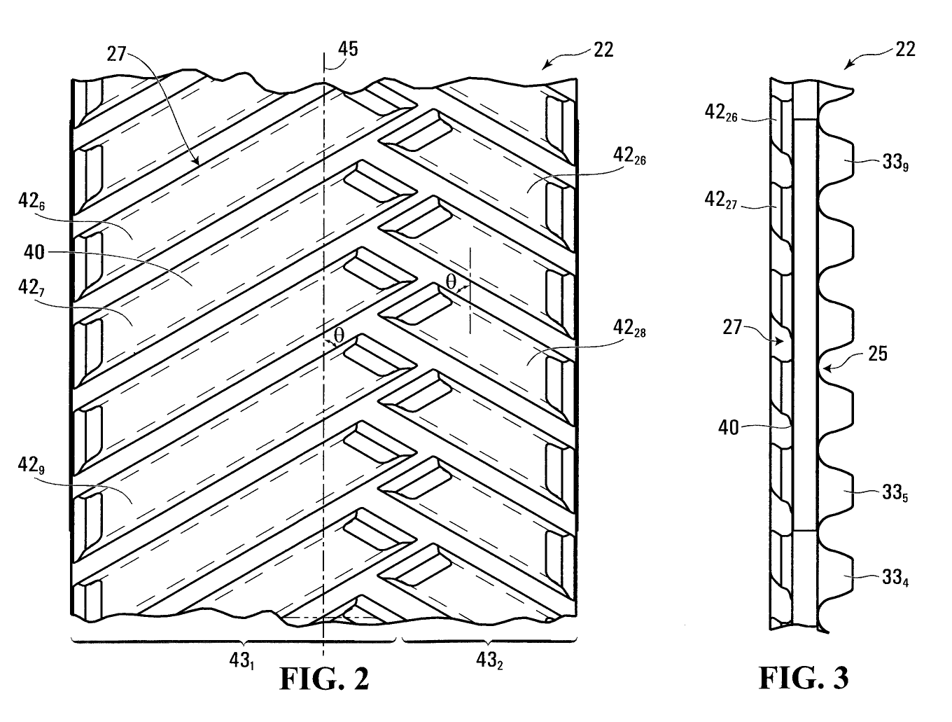

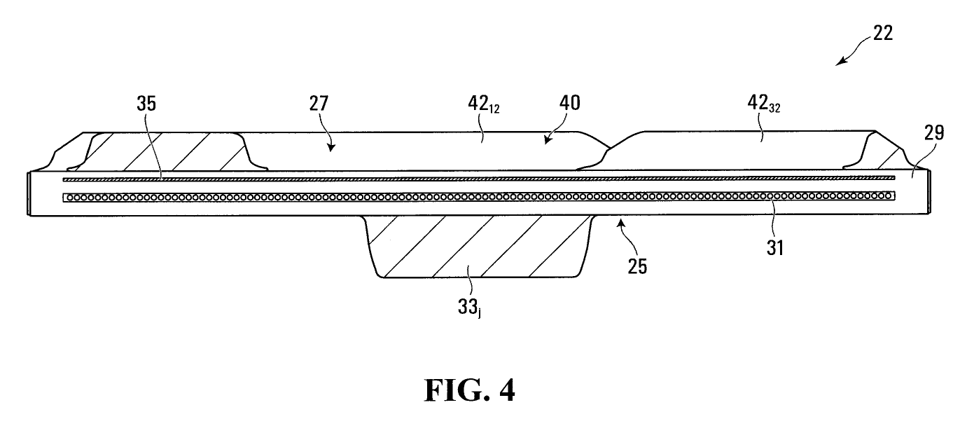

The endless track 22 provides traction to the construction vehicle 10 on the ground. With additional reference to FIGS. 2 to 4, the endless track 22 comprises an inner side 25 engaging the wheels 24, 26, 28₁-28₄ and defining an inner area of the endless track 22 in which these wheels are located. The endless track 22 also comprises a ground-engaging outer side 27 engaging the ground on which the construction vehicle 10 travels.

In this embodiment, the endless track 22 comprises an elastomeric body 29 containing rubber or other suitable elastomeric material. The elastomeric body 29 is reinforced with reinforcements, including a layer of longitudinal cables 31 (e.g., steel cords) and one or more layers of fabric 35. In other embodiments, the endless track 22 may be constructed in various other ways using various other materials and components (e.g., transverse metallic core members).

The inner side 25 of the endless track 22 engages the drive wheel 24 in order to cause the endless track 22 to be driven. More particularly, in this embodiment, the inner side 25 of the endless track 22 comprises a plurality of drive lugs 33₁-33_{N} that interact with the drive wheel 24 in order to cause the endless track 22 to be driven. In this example, the drive wheel 24 comprise a drive sprocket having teeth or bars that engage respective ones of the drive lugs 33₁-33_{N} of the endless track 22 in order to drive the endless track 22. The drive lugs 33₁-33_{N} may also serve to guide the endless track 22 as it is driven and in that sense can also be viewed as guide lugs. In other embodiments, the inner side 25 of the endless track 22 may be configured in other ways depending on a configuration of the drive wheel 24. For instance, in some embodiments, the inner side 25 of the endless track 22 may comprise recesses or holes in which can enter teeth of the drive wheel 24 in order to drive the endless track 22. In other embodiments, the inner side 25 of the endless track 22 may be frictionally driven by the drive wheel 24.

The ground-engaging outer side 27 comprises a tread pattern 40 producing traction force components when the construction vehicle 10 moves on the ground. More specifically, as the endless track 22 is driven by the drive wheel 24, the tread pattern 40 produces longitudinal traction force components acting on the endless track 22 in a longitudinal direction generally parallel to a longitudinal axis 45 of the endless track 22 such that a resultant of the longitudinal traction force components is a longitudinal force acting on the endless track 22 in the longitudinal direction. This longitudinal force can be used to move the construction vehicle 10 forward or backward on the ground.

In addition, as further discussed below, the tread pattern 40 is characterized in that, when the construction vehicle 10 moves on the ground, the tread pattern 40 produces lateral traction force components acting laterally on the endless track 22 such that a resultant of the lateral traction force components is a net non-null lateral force acting on the endless track 22 in a lateral direction generally perpendicular to the longitudinal axis 45 (i.e., in a left-to-right or right-to-left direction). This net non-null lateral force (which may also be referred to as a net positive lateral force) can be used for various purposes. For example, in some cases, the net non-null lateral force produced by the endless track 22 can be used to oppose undesirable side loads and/or tendencies for lateral movements that may be experienced by the endless track 22 due to intrinsic mechanical imbalances which may arise in the construction vehicle 10 (e.g., “toe-in”, negative camber, etc.), motion of the construction vehicle 10 on the ground (e.g., if the vehicle 10 moves on an inclined ground area, or turns almost exclusively or significantly more often on one side), and/or use of the working implement 18 (e.g., if the working implement 18 creates a non-uniform lateral load distribution whereby the vehicle 10 is subjected to a higher loading on one of its sides). By opposing such undesirable side loads and/or tendencies for lateral movements, the net non-null lateral force may in some cases help to, for instance, reduce wear of the endless track 22 (e.g., reduce wear of the drive lugs 33₁-33_{N}), reduce a tendency for detracking of the endless track 22, and/or provide additional centering of the construction vehicle 10 along its intended path of travel (e.g., on an inclined ground area).

The tread pattern 40 may be designed in various ways to produce a net non-null lateral force. For example, in this embodiment, the tread pattern 40 is asymmetrical relative to the longitudinal axis 45 of the endless track 22. That is, in this case, the longitudinal axis 45 is a central longitudinal axis relative to which the tread pattern 40 is asymmetrical. This asymmetry results in the tread pattern 40 producing opposite lateral traction force components having different magnitudes such that a resultant of these opposite lateral traction force components is a net non-null lateral force acting on the endless track in a lateral direction generally perpendicular to the central longitudinal axis 45.

More particularly, in this embodiment, the tread pattern 40 comprises a plurality of tread projections 42₁-42_{P} that project outwardly. In this example, each of the tread projections 42₁-42_{P} has an elongated shape. The tread projections 42₁-42_{P} may have various other shapes in other examples (e.g., curved shapes, shapes with straight parts at different angles, etc.). Also, in this example, each of the tread projections 42₁-42_{P} is angled relative to the central longitudinal axis 45, i.e., it defines an acute angle θ relative to the central longitudinal axis 45. In this case, the acute angle θ is about 60°. The acute angle θ may have various other values in other examples (e.g., between 50° and)70°.

In this embodiment, the tread projections 42₁-42_{P} are arranged in two (2) rows 43₁, 43₂ running longitudinally along the endless track 22, with the tread projections 42₁-42ₖ being part of the row 43₁ and the tread projections 42ₖ₊₁-42_{P} being part of the row 43₂. The tread projections 42₁-42ₖ of the row 43₁ are longer than the tread projections 42ₖ₊₁-42_{P} of the row 43₂. Thus, in this case, the tread projections 42₁-42ₖ of the row 43₁ cross the central longitudinal axis 45 while the tread projections 42ₖ₊₁-42_{P} of the row 43₂ do not. In this example, the tread projections 42₁-42ₖ of the row 43₁ are about twice as long as the tread projections 42ₖ₊₁-42_{P} of the row 43₂. There may be a greater or smaller difference in length between the tread projections 42₁-42ₖ of the row 43₁ and the tread projections 42ₖ₊₁-42_{P} of the row 43₂ in other examples.

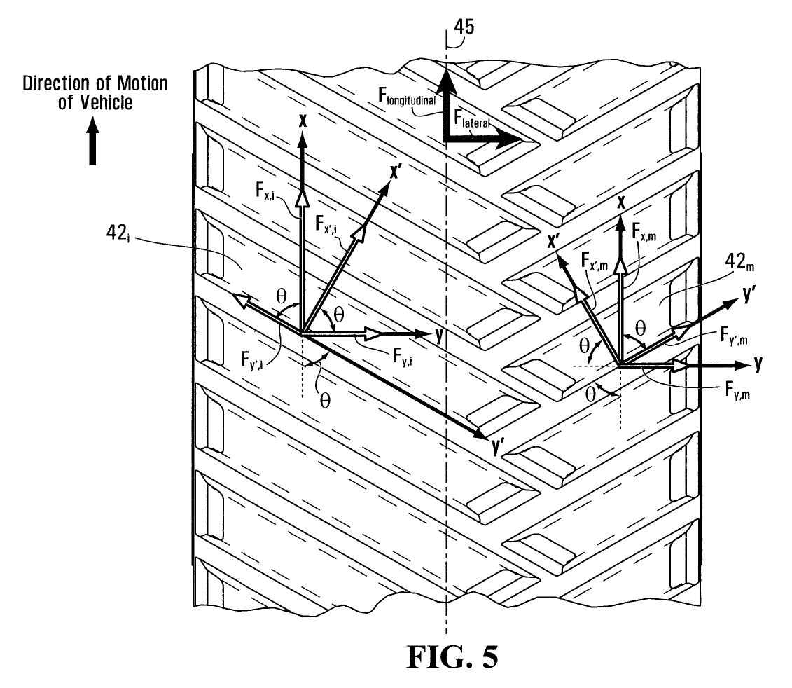

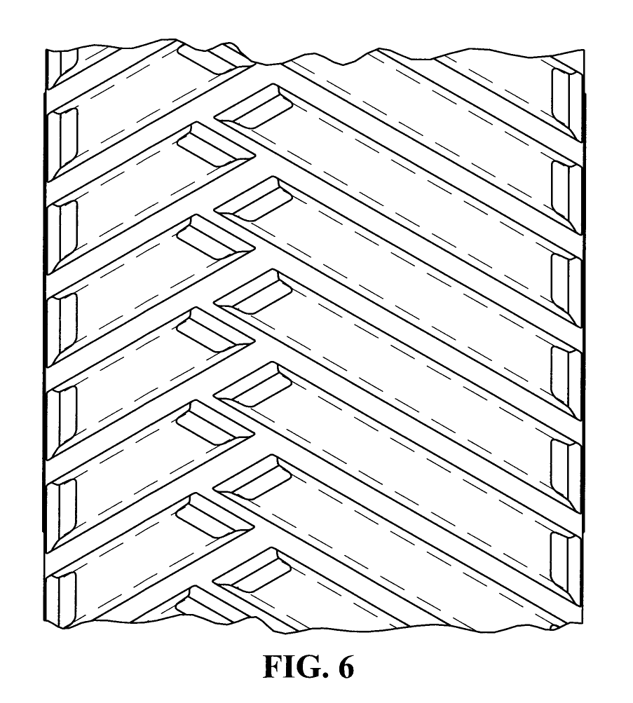

FIG. 5 illustrates an example of traction force components produced by the tread pattern 40 when the construction vehicle 10 moves on the ground (as viewed from the ground). In this example, the traction force components produced by a pair of projections of the tread projections 42₁-42_{P} that are located on a bottom ground-engaging run of the endless track 22, namely the tread projection 42ᵢ in the row 43₁ and the tread projection 42ₘ in the row 43₂, will be considered. Similar considerations apply to other ones of the tread projections 42₁-42_{P} that are located on the bottom ground-engaging run of the endless track 22.

Without wishing to be bound by theory, it is believed that, as the tread projection 42ᵢ engages the ground due to movement of the endless track 22, there is a normal force component F_{x′,i} acting on its vertical face along a normal x′-axis. There may also be a shear force component F_{y′,i} acting on the vertical face of tread projection 42ᵢ along a tangential y′-axis due to sliding of ground material along that face towards a side edge of the endless track 22. Thus, there is a longitudinal traction force component F_{x,i} acting along a longitudinal x-axis generally parallel to the central longitudinal axis 45 of the endless track 22, as well as a lateral traction force component F_{y,i} acting along a lateral y-axis generally perpendicular to the central longitudinal axis 45 of the endless track 22. In this example, these force components can be viewed as: F_{x,i}=F_{x′,i} sin θ+F_{y′,i} cos θ and F_{y,i}=F_{x′,i} cos θ−F_{y′,i} sin θ.

The normal force component F_{x′,i} acting on the vertical face of the tread projection 42ᵢ can be viewed as being proportional to an area of this face, and thus a length Lᵢ of this face, such that F_{x′,i}=f(γₛ, h_{b}, C, φ)Lᵢ where f(γₛ, h_{b}, C, φ) is a function of various parameters, such as ground parameters (e.g., a weight density γₛ and a cohesion C of the ground, an internal shearing resistance φ of the ground), a sinkage level h_{b} of the tread projection 42ᵢ in the ground, or other parameters. The shear force component F_{y′,i} acting on the vertical face of tread projection 42ᵢ can be also be viewed as being proportional to an area of this face, and thus a length Lᵢ of this face, such that F_{y′i}=g(γₛ, h_{b}, C, φ, δ, B)Lᵢ where g(γₛ, H_{b}, C, φ, δ, B) is a function of various parameters, such as those mentioned above, an angle of friction δ between the ground and the vertical face of the tread projection 42ᵢ, an adhesion B between the ground and the vertical face of the tread projection 42ᵢ, or other parameters. Therefore, the longitudinal traction force component F_{x,i} can be viewed as F_{x,i}=[f(γₛ, h_{b}, C, φ)sin θ+g(γₛ, h_{b}, C, φ, δ, B)cos θ]Lᵢ, while the lateral traction force component F_{y,i} can be viewed as F_{y,i}=[f(γₛ, h_{b}, C, φ)cos θ−g(γₛ, h_{b}, C, φ, δ, B)sin θ]Lᵢ.

Similarly, as the tread projection 42ₘ engages the ground due to movement of the endless track 22, there is a longitudinal traction force component F_{x,m} and a lateral traction force component F_{y,m} that can be viewed as F_{x,m}=[f(γₛ, h_{b}, C, φ)sin θ+g(γₛ, h_{b}, C, φ, δ, B)cos θ]Lₘ and F_{y,m}=[−f(γₛ, h_{b}, C, φ)cos θ+g(γₛ, h_{b}, C, φ, δ, B)sin θ]Lₘ, where Lₘ is a length of the vertical face of the tread projection 42ₘ.

By adding the longitudinal traction force components and lateral traction force components produced by the tread projections 42ᵢ, 42ₘ, it can be seen that, in this example, a total longitudinal traction force component produced by this pair of projections is F_{x,i+m}=[f(γₛ, h_{b}, C, φ)sin θ+g(γₛ, h_{b}, C, φ, δ, B)cos θ](Lᵢ+Lₘ), while a total lateral traction force component produced by this pair of projections is F_{y,i+m}=[f(γₛ, h_{b}, C, φ)cos θ−g(γₛ, h_{b}, C, φ, γ, B)sin θ](Lᵢ−Lₘ). Since in this example the tread projection 42ᵢ is longer than the tread projection 42ₘ, the length Lᵢ of the vertical face of the tread projection 42ᵢ is greater than the length Lₘ of the vertical face of the tread projection 42ₘ and thus the total lateral traction force component F_{y,i+m} produced by this pair of projections is positive (i.e., non-null) and acts in the lateral direction along which extends the lateral y-axis. In other words, the lateral traction force components F_{y,i} and F_{y,m}, which are opposite to one another, have different magnitudes such that they result in the total lateral traction force component F_{y,i+m} being non-null and acting in the lateral direction of the largest one of these lateral traction force components (in this case, F_{y,i}).

When summing all the longitudinal traction force components and lateral traction force components produced by the tread pattern 40 when the construction vehicle 10 moves on the ground, it can be seen that a resultant of the longitudinal traction force components (such as F_{x,i} and F_{x,m}) is a longitudinal force F_{longitudinal} acting on the endless track 22 in the longitudinal direction. This longitudinal force can be used to move the construction vehicle 10 forward or backward on the ground.

It can also be seen that a resultant of the lateral traction force components (such as F_{y,i} and F_{y,m}) is a net non-null lateral force Fₗₐₜₑᵣₐₗ acting on the endless track 22 in a lateral direction (in this example, a left-to-right direction). The magnitude of the lateral force Fₗₐₜₑᵣₐₗ depends on various factors, such as, for example, the number of tread projections 42₁-42_{P} in contact with the ground, the shape of the tread projections 42₁-42_{P}, the torque with which the endless track 22 is driven, and/or other factors. The lateral force Fₗₐₜₑᵣₐₗ produced by the endless track 22 can be used for various purposes.

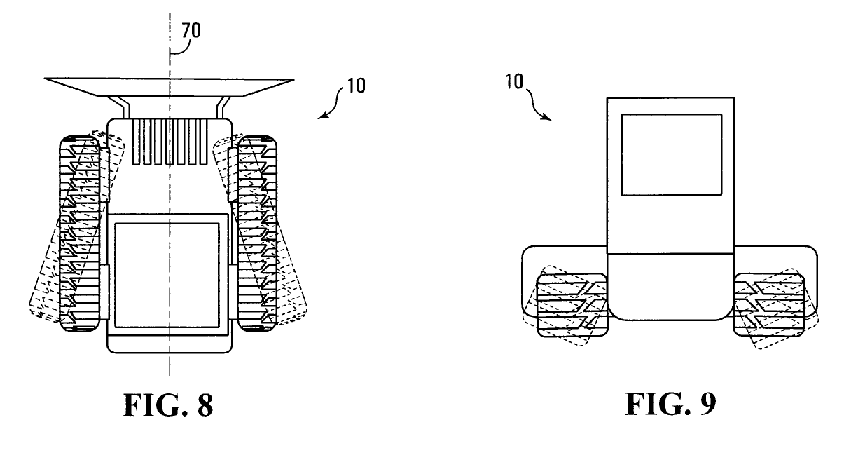

For example, consider a situation in which the construction vehicle 10 exhibits intrinsic mechanical imbalances such as mechanical misalignments that cause the endless tracks 22 to tend to move laterally with respect to the vehicle 10. For instance, the weight of the construction vehicle 10 and/or other loads acting on the vehicle 10 may sometimes cause portions of the frame 12 and/or certain axles which connect the prime mover 14 to the track assemblies 16₁, 16₂ to deflect. In some cases, as shown (in dotted lines) in FIG. 9, this may cause negative camber for the vehicle 10, tending to move the endless track 22 laterally outwardly. In other cases, as shown (in dotted lines) in FIG. 8, this may cause a tendency for “toe-in” of the endless track 22, whereby the front of the track 22 tends to move laterally inwardly. In these and other cases, the lateral force Fₗₐₜₑᵣₐₗ produced by the tread pattern 40 may oppose a tendency for lateral movement of the endless track 22, and may thus help to reduce wear of the endless track 22.

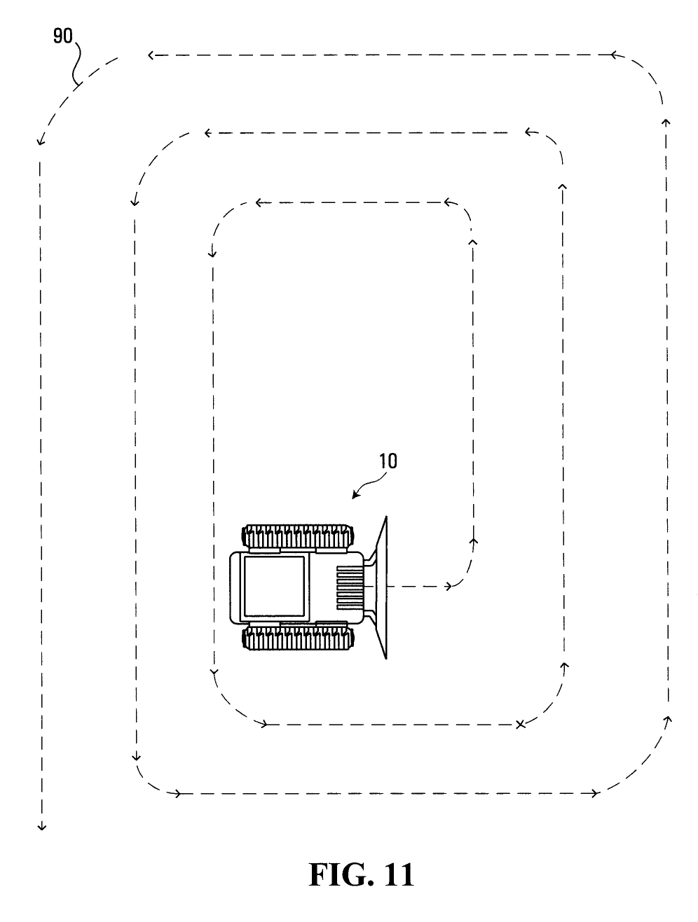

As another example, consider a situation in which the construction vehicle 10 turns almost exclusively or significantly more often on one side than the other. FIG. 11 shows an example of such a situation, where the construction vehicle 10 with the working implement 18 is being used to level a ground surface (e.g., a surface for an airport runway) by following a path 90. As it follows the path 90, the vehicle 10 makes a series of right-hand turns such that the working implement 18 may pass repeatedly over the ground surface in order to apply a certain amount of leveling to it. In this situation, the lateral force Fₗₐₜₑᵣₐₗ produced by the tread pattern 40 of the endless track 22 may help to counter the effect of the repeated right-hand turns on the endless track 22. For instance, this may help to reduce wear of the endless track 22, in particular the drive lugs 33₁-33_{N} along its inner side 25, and thus help extend the operational lifespan of the endless track 22.

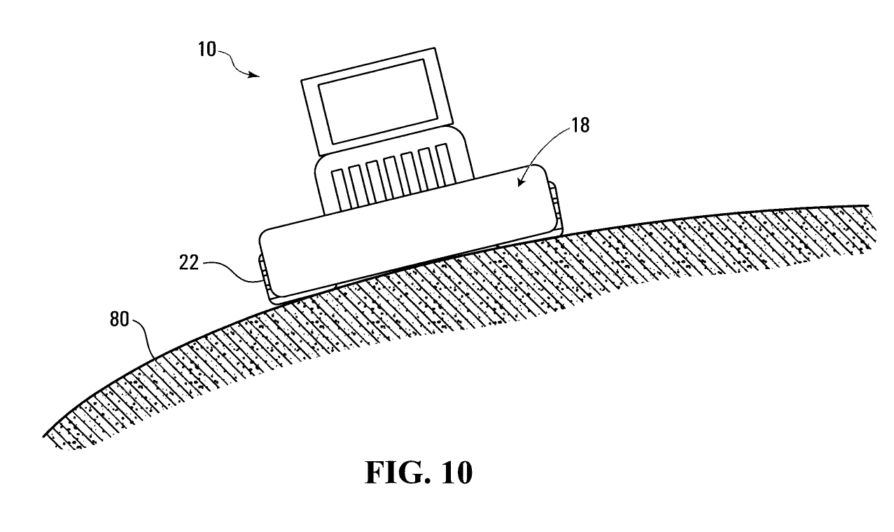

As yet another example, consider a situation in which the construction vehicle 10 often travels on inclined terrain defining a side slope 80, as shown in FIG. 10. The effect of the slope 80 on the vehicle 10 may cause the vehicle 10 to become somewhat imbalanced. As a result, the actual path that the vehicle 10 follows may parallel the direction of the slope 80 somewhat, resulting in a difference from its intended path as set by the operator (also known as a “drift angle” or “crab angle”). In this situation, the lateral force Fₗₐₜₑᵣₐₗ produced by the tread pattern 40 of the endless track 22 may help to counter the effect of the side slope 80. For instance, the lateral force Fₗₐₜₑᵣₐₗ may be generated in an opposite direction of the slope 80. As a result, the lateral force Fₗₐₜₑᵣₐₗ may counter somewhat the imbalance caused by the slope 80 on the vehicle 10 and may reduce wear of the endless track 22 and extend its operational lifespan, especially in cases where the construction vehicle 10 is used for extended periods of time along inclined terrain.

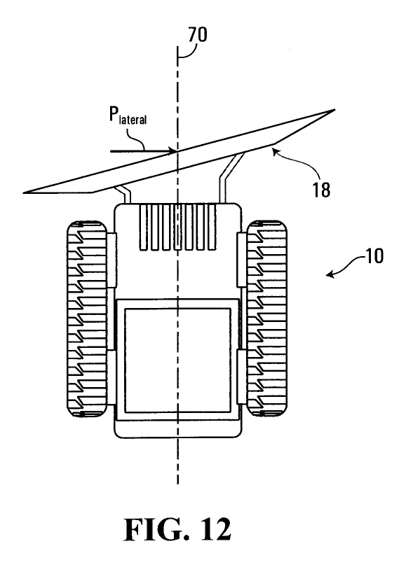

As yet another example, consider a situation in which the working implement 18 of the construction vehicle 10 creates a non-uniform lateral load distribution whereby the vehicle 10 is subjected to a higher loading on one of its sides which tends to steer the vehicle 10 in a particular direction. For instance, with reference to FIG. 12, consider a case where the working implement 18, which in this example is a dozer blade, is angled relative to a longitudinal axis 70 of the construction vehicle 10 (i.e., is oriented at an acute angle relative to the longitudinal axis 70) in order to push objects or shove soil, debris or other material towards a left side of the vehicle 10. This causes the construction vehicle 10 to be subjected to a lateral load Pₗₐₜₑᵣₐₗ acting on the working implement 18 in a left-to-right direction, which tends to generally steer the vehicle 10 in the left-to-right direction. In this situation, the lateral force Fₗₐₜₑᵣₐₗ produced by the tread pattern 40 of the endless track 22 may be used to oppose the effect of the lateral load Pₗₐₜₑᵣₐₗ acting on the working implement 18, which may help reduce wear on the endless track 22.

In other embodiments where the working implement 18 is another type of working implement, other situations may arise in which the working implement 18 creates a non-uniform lateral load distribution whereby the vehicle 10 is subjected to a higher loading on one of its sides which tends to steer the vehicle 10 in a given direction. For example, in some embodiments, the working implement 18 may be an elongated moveable device (e.g., a grapple or extendible crane) that is located on one side of the construction vehicle 10 and is likely to be deployed during use at an angle such that it extends transversally to the longitudinal axis 70 of the vehicle 10. This may result in a lateral load on vehicle 10 which causes a tendency for the vehicle 10 to steer in a particular direction and thus cause a drift angle to develop between its intended direction and its actual path. In such situations, the lateral force Fₗₐₜₑᵣₐₗ produced by the tread pattern 40 of the endless track 22 may be used to oppose the effect of the lateral load caused by the working implement 18.

As yet another example, the lateral force Fₗₐₜₑᵣₐₗ produced by the endless track 22 may help to counter a tendency for detracking of the endless track 22 that may otherwise arise in some cases.

The examples considered above illustrate some situations in which the lateral force Fₗₐₜₑᵣₐₗ produced by the endless track 22 may be useful. It will be appreciated that this lateral force may be useful in various other situations, depending on the type of construction vehicle 10 and its working environment.

While in the embodiment considered above the tread pattern 40 is configured in a particular manner to produce the lateral force Fₗₐₜₑᵣₐₗ, the tread pattern 40 may be configured in various manners to produce such a lateral force in other embodiments.

For example, in some embodiments, as shown in FIG. 6, the tread projections 42ₖ₊₁-42_{P} of the row 43₂ may be longer than the tread projections 42₁-42ₖ of the row 43₁. In such embodiments, the lateral force Fₗₐₜₑᵣₐₗ produced by the endless track 22 is directed in a lateral direction opposite to that produced in the embodiment considered above in connection with FIG. 2.

As another example, in some embodiments, different ones of the tread projections 42₁-42ₖ of the row 43₁ may have different shapes, and/or different ones of the tread projections 42ₖ₊₁-42_{P} of the row 43₂ may have different shapes. For instance, in some cases, different ones of the tread projections 42₁-42ₖ of the row 43₁ may have different lengths, and/or different ones of the tread projections 42ₖ₊₁-42_{P} of the row 43₂ may have different lengths. In a similar manner, in some embodiments, different ones of the tread projections 42₁-42_{P} may define respective acute angles θ having different values.

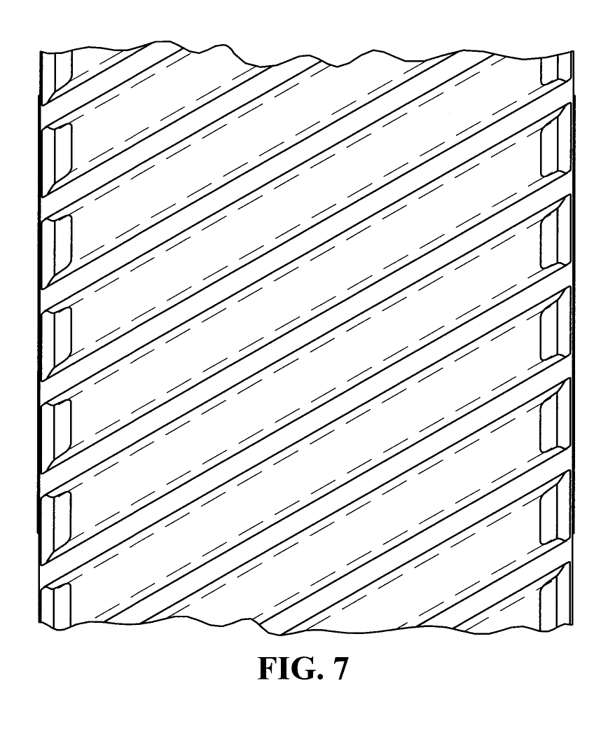

As yet another example, in some embodiments, the tread projections 42₁-42_{P} of the tread pattern 40 may be arranged in any number of rows running longitudinally along the endless track 22. For instance, in some cases, as shown in FIG. 7, the tread projections 42₁-42ₚ of the tread pattern 40 may be arranged in a single row. In other cases, the tread projections 42₁-42_{P} of the tread pattern 40 may be arranged in three (3) or more rows. Also, in some embodiments, the tread projections 42₁-42_{P} of the tread pattern 40 may be arranged in various configurations that do not form any row.

While in the embodiment considered above the off-road work vehicle 10 is a construction vehicle designed to perform construction work, in other embodiments, the off-road work vehicle 10 may be an agricultural vehicle (e.g., a harvester, a combine, a tractor, etc.) designed to perform agricultural work, a forestry vehicle (e.g., a feller-buncher, a tree chipper, a knuckleboom loader, etc.) designed to perform forestry work, or any other work vehicle designed to perform another type of industrial work (e.g., mining, geophysical surveying, etc.) in off-road conditions. In such embodiments, the off-road work vehicle 10 may be equipped with various types of working implements depending on the nature of the work to be performed (e.g., a combine head for an agricultural vehicle, a mulching head for a forestry vehicle, etc.).

Although various embodiments and examples have been presented, this was for the purpose of describing, but not limiting, the invention. Various modifications and enhancements will become apparent to those of ordinary skill in the art and are within the scope of the invention, which is defined by the appended claims.

1. An endless track for providing traction to an off-road work vehicle, the endless track having a longitudinal axis and comprising:
an inner side for engaging a drive wheel of the off-road work vehicle to move the endless track; and
a ground-engaging outer side for engaging the ground, the ground-engaging outer side comprising a tread pattern characterized in that, when the off-road work vehicle moves on the ground, the tread pattern produces lateral traction force components acting laterally on the endless track such that a resultant of the lateral traction force components is a net non-null lateral force acting on the endless track in a lateral direction generally perpendicular to the longitudinal axis.

2. An endless track as claimed in claim 1, the lateral traction force components including opposite lateral traction force components having different magnitudes.

3. An endless track as claimed in claim 2, the longitudinal axis being a central longitudinal axis, the tread pattern being asymmetrical relative to the central longitudinal axis.

4. An endless track as claimed in claim 3, the tread pattern comprising a plurality of tread projections projecting outwardly, the tread projections being arranged in at least two rows running longitudinally along the endless track, the projections in a first one of the rows crossing the central longitudinal axis, the projections in a second one of the rows not crossing the central longitudinal axis.

5. An endless track as claimed in claim 3, the tread pattern comprising a plurality of tread projections projecting outwardly, the tread projections being arranged in at least two rows running longitudinally along the endless track, at least some of the projections in a first one of the rows being longer than at least some of the projections in a second one of the rows.

6. An endless track as claimed in claim 3, the tread pattern comprising a plurality of tread projections projecting outwardly, the tread projections being arranged in at least two rows running longitudinally along the endless track, at least some of the projections in a first one of the rows having a first shape, at least some of the projections in a second one of the rows having a second shape different from the first shape.

7. An endless track as claimed in claim 1, comprising an elastomeric body reinforced with reinforcements.

8. An endless track as claimed in claim 7, the reinforcements comprising at least one of a layer of longitudinal cables and a layer of fabric.

9. An endless track as claimed in claim 7, the reinforcements comprising a plurality of transverse metallic core members.

10. An off-road work vehicle comprising an endless track as claimed in claim 1.

11. An off-road work vehicle as claimed in claim 10, the off-road work vehicle being a construction vehicle, an agricultural vehicle or a forestry vehicle.

12. A method for opposing a tendency for an endless track of an off-road work vehicle to move in a first lateral direction as the off-road work vehicle moves on the ground, the method comprising:
providing the endless track with a tread pattern that generates, as the off-road work vehicle moves on the ground, a net non-null lateral force acting on the endless track in a second lateral direction generally opposite the first lateral direction; and
driving the off-road work vehicle to give rise to the net non-null lateral force.

13. A method as claimed in claim 12, the tendency for the endless track to move in the first lateral direction resulting from an intrinsic mechanical imbalance of the off-road work vehicle.

14. A method as claimed in claim 13, the intrinsic mechanical imbalance tending to induce at least one of negative camber of the off-road work vehicle and toe-in of the endless track.

15. A method as claimed in claim 12, the net non-null lateral force being a resultant of opposite lateral traction force components having different magnitudes.

16. A method as claimed in claim 12, the endless track having a central longitudinal axis, the tread pattern being asymmetrical relative to the central longitudinal axis.

17. A method as claimed in claim 16, the tread pattern comprising a plurality of tread projections projecting outwardly, the tread projections being arranged in at least two rows running longitudinally along the endless track, the projections in a first one of the rows crossing the central longitudinal axis, the projections in a second one of the rows not crossing the central longitudinal axis.

18. A method as claimed in claim 16, the tread pattern comprising a plurality of tread projections projecting outwardly, the tread projections being arranged in at least two rows running longitudinally along the endless track, at least some of the projections in a first one of the rows being longer than at least some of the projections in a second one of the rows.

19. A method as claimed in claim 16, the tread pattern comprising a plurality of tread projections projecting outwardly, the tread projections being arranged in at least two rows running longitudinally along the endless track, at least some of the projections in a first one of the rows having a first shape, at least some of the projections in a second one of the rows having a second shape different from the first shape.

20. A method for reducing wear in an endless track of an off-road work vehicle carrying a working implement that creates a non-uniform lateral load distribution whereby the vehicle is subjected to a higher loading on one of its sides which tends to steer the vehicle in a first direction, the method comprising:
providing the endless track with a tread pattern that generates, as the vehicle moves on the ground, a net force acting laterally on the endless track and tending to steer the vehicle in a second direction that is generally opposite the first direction; and
driving the vehicle on the ground to give rise to the net force.
